(19) United States
(12) Patent Application Publication
(10) Pub. No.: US 2017/0363258 A1
(43) Pub. Date: Dec. 21, 2017

(54) HAND MOUNTED MIRROR AND INDICATOR DEVICE

(71) Applicant: Paul Stephen TOLLEY, Congleton (GB)

(72) Inventor: Paul Stephen TOLLEY, Congleton (GB)

(21) Appl. No.: 15/675,680

(22) Filed: Aug. 11, 2017

Related U.S. Application Data
(63) Continuation-in-part of application No. PCT/GB2016/000026, filed on Feb. 8, 2016.

(30) Foreign Application Priority Data
Feb. 11, 2015 (GB) 1502239.5

(51) Int. Cl. F21L 4/00; F21V 21/08; F21V 23/02; F21V 23/04; F21V 7/05

(52) U.S. Cl. CPC F21L 4/00; F21V 23/0492; F21V 23/0485; F21V 23/0471; F21V 7/05; F21V 23/02; F21V 21/0816; F21V 23/0442

(57) ABSTRACT

The invention is a universal safety device for cyclists which can be used by anyone in any country with no modifications. The safety mirror and an indicator device (100) for wearing on a hand comprises: a first face (10A) housing a mirror (20) and a second opposed face (10B) that interfaces a wearer's hand in use. A strap (50) is provided for securing the device to a wearer's hand. A light (30) powered by a battery (70) is arranged on an end (40) of the device (100).

The light (30) and the strap (50) are arranged such that the light (30) projects past the hand of the wearer so that the light (30) is not obstructed by the wearer's hand when viewed from a position in front of the wearer during use. The device (100) has a switch (90) operatively connected to the light (30) to activate the light (30) when triggered.

### FIELD OF INVENTION

This invention relates to a hand mounted mirror and indicator device, for example for safely viewing objects to the rear of an individual on a bicycle and for indicating a manoeuvre. The device improves safety of a wearer by notifying third parties of the intentions of the wearer and enables the wearer to observe a rear view to identify approaching traffic.

### BACKGROUND

When a cyclist is travelling on a road they must turn their head to see if any traffic is approaching from behind and to signal with their arm their intended direction of turn. This can make the bicycle unstable especially in the case of a child rider or an older person, who may have problems twisting their back or neck and are not agile, when they wish to make a turn.

This can be dangerous as the cyclist has to take their eyes off the road ahead and can often be startled when turning their head if a car is very close or is overtaking them. It is also very difficult to gauge when to make a manoeuvre when a stream of traffic is behind a cyclist. It can also be difficult or uncomfortable to have to repeatedly turn around in order to judge the best time to make a turning manoeuvre.

The use of a conventional mirror can lead to a number of difficulties, not least that the cyclist, who usually travels close to a kerb, where there may be pot holes and grids which subject a mirror mounted on a bicycle handlebar, to vibration and distortion.

In addition fixed mirrors have a blind spot. One aim of the present invention is to eliminate blind spots associated with a fixed mirror.

Another problem with fixed mirrors is that they are awkward to store when transporting the bicycle on a conventional carrier rack.

The present invention overcomes these problems by providing a device that has a mirror and an indicating means in a single device that is mounted on the hand of a wearer.

### PRIOR ART

US Patent Application US2011/0078842 (Tang) discloses a glove and illuminating indicating system.

UK patent application GB2509141 (Else) discloses an indicator glove.

US Patent Application US2011/0258753 (Jacque) discloses a glove comprising an outer shell with a back portion where a mirror can be adjusted.

US Patent Application US2011/0235310 (Chen) discloses a hand-wearing assembly and a side mirror mount.

US Patent Application US2009/0034102 (Bartlett) discloses a handheld mirror with first and second body portions.

Korean Patent Application KR20130048875 (Min) discloses a safety apparatus to indicate direction.

### SUMMARY OF INVENTION

According to a first aspect of the present invention there is provided a safety mirror and an indicator device for wearing on a hand comprising: a first face housing a mirror and a second opposed face that interfaces a wearer's hand in use; a strap for securing the device to a wearer's hand; a light powered by a battery, the light arranged on an end of the device; the light and the strap are arranged such that the light projects past the hand of the wearer so that the light is not obstructed by the wearer's hand when viewed from a position in front of the wearer during use, wherein the device has a switch operatively connected to the light to activate the light when triggered.

An advantage of the device is that it has an indication facility.

In this way a wearer of the device can position their hand to view the mirror to observe a rear view, such as approaching traffic whilst also activating the light to alert surrounding persons, cyclists or vehicles of an intention to turn.

Advantageously the strap is positioned on the second face of the device such that the light is biased to project and extend from a side edge of a wearer's hand in the same plane as the wearer's palm. In this way light is visible from all around and in particular from both a front and rear view so that passing, approaching or following traffic can clearly see the indicating light when activated.

Furthermore this arrangement enables a wearer to position their hands on the handlebars in a regular grip without the device interfering. Advantageously the device is suitable for use on any bicycle or type of handlebars.

The design of the device incorporates the specific positioning of the strap which ensures that the light is viewable for both upcoming, oncoming and passing traffic with no adjustment required by the wearer. In this way the device serves as both a front and rear indicator in one device. Advantageously the position of the strap on the device ensures that device is suitable for any wearer regardless of the size of the wearer's hand as the light will always extend beyond a wearer's hand.

In some embodiments the strap may be adjustable, for example being a two part hook and loop strap or having an adjustable buckle to shorten or lengthen the strap to comfortably fit a user.

In some embodiments the strap may be elasticated or include an elasticated portion so as to readily fit various users and for additional comfort.

The strap may be formed from a breathable material for additional comfort and improved hygiene.

Preferably the switch includes an accelerometer that is activated upon movement of a wearer's hand. In this way the indicating light is automatically activated when a wearer moves their hand to an indicating position outstretched to their left side or right side of the direction of travel of the bicycle.

Typically the accelerometer must move through a range of at least 90 degrees in order to trigger activation of the light.

In some embodiments the switch may be a reed switch that is activated by passing the device through a magnetic field that activates the reed switch thereby activating or deactivating the light. For example a magnet may be located on a wearer, on the bicycle or on a cycle helmet and the device, as it passes by the magnet, activates or deactivates the light.

In yet a further embodiment the switch may include a touch sensor. For example a first face, that houses the mirror, or an end of the device, may include a touch sensor or a touch sensitive region that activates and/or deactivates the light upon touch.

In some embodiments the mirror may act as a capacitance screen that activates and/or deactivates the light upon touch.

For devices having a touch sensor, during use a wearer may tap part of the device against their body, such as their leg, chin or against part of the bicycle, such as the handlebar, or against their helmet, in order to activate the light when indicating and prior to turning.

In another embodiment the strap may include a sensor that can be activated or deactivated to trigger the light. For example the strap may include a pressure sensor that activates the light when a wearer's hand is removed from the handlebar.

In another embodiment the device may include an audio sensor that is activated on detection of a sound, for example the sound sensor may include a voice activated device.

In yet a further embodiment the device may be activated by a wireless signal received from a remote device. For example a signal may be transmitted from a smartphone to the device to trigger the light. The signal may be transmitted by a radio frequency (RF) signal such as Bluetooth, via a mobile network or via a satellite.

In an advanced embodiment the device may receive signals from a photo that correspond to geographic location of a rider. For example a global positioning device may transmit location signals to the device to automatically pick up a forthcoming turn.

The device may have an on and off switch but ideally a sensor detects a period of non-use and switches the device into a sleep or quiescent mode, so no actual switch is needed.

Preferably the device has a robust and tough outer casing that encloses the battery, switch and at least one light. An inner face of the casing may be cushioned and adapted to receive the components and to protect them should the device be dropped. Optionally the inner surface of the casing may be moulded to receive parts.

Ideally the device is waterproof to protect all electrical parts in wet conditions. The casing of the device is typically formed from a lightweight, strong, durable material such as one or more layers of a synthetic plastics material. The casing ideally includes rubber or silicone seals to hermetically seal any parts that may have to be opened, for example in order to replace a battery.

In a preferred embodiment the device casing is formed in two parts that are contain so as to define a cavity in which components are arranged. The parts are separated to access the batteries. A seal is provided between the two parts to protect the components from water ingress.

Preferably the body is substantially oblong in form and does not have any sharp edges. In this way the device can fit comfortably across the back of a wearer's hand.

The at least one light is arranged under a transparent or translucent cover that is connected to the body. Preferably the light is arranged against or near to a reflective surface to enhance the amount of light reflected.

In some embodiments the light cover or surrounding region includes a diffusing surface.

Preferably the light or lights are light emitting diodes (LEDs) and/or a light emitting polymer (LEP) or similar material that may be formed and which emits light when an electric current passes through it. Typically the light or lights are programmed to flash.

In a preferred embodiment a plurality of surface LEDs are arranged to disperse light over a greater area. For example, a surface LED may be mounted on each opposed side of the PCB and on the end of the device. In this way the lights emit light in plural directions for greater visibility of a wearer. Advantageously this avoids dulls spots which can occur when LEDs all mounted in the same orientations.

Lights may be arranged to flash at different speeds and in different colours depending upon applied signals. Preferably the device light flashes orange to mimic a conventional vehicle indicating light.

Typically the cover is also orange. In some embodiments the cover may be clear and an orange LED may be provided.

Ideally the battery is arranged under a lid to permit its easy removal and convenient replacement. The device may have more than one battery.

In some embodiments the battery is rechargeable. The device may include a port to permit connection to a power supply for charging the rechargeable battery.

In another embodiment the device may have a terminal suitable for being received by a docking station for charging.

In yet another embodiment the device may include at least on imager, such as a camera or high definition camera for capturing image data. The imager may have a lens provided on a first face of the device and images captured by the imager may be displayed in real time on a screen on the first face to provide the wearer with a view of wherever the imager is directed. The screen may be provided as an alternative or in addition to the mirror.

In some embodiments having an imager a memory means may be provided to record and store collected data.

Preferred embodiments of the invention will now be described, by example only, and with reference to the Figures in which:

### BRIEF DESCRIPTION OF THE FIGURES

FIG. 1 shows a top view of one embodiment of the mirror and indicator device;

FIG. 2 shows a bottom view of the mirror indicator device in FIG. 1;

FIG. 3 shows an exploded view of the device in FIG. 1;

FIG. 4 illustrates the device in use;

FIG. 5 shows a first face of the device;

FIG. 6 shows a block diagram indicating system inputs and outputs;

FIG. 7 shows a cross section of the device;

FIG. 8 shows a mode flow chart;

FIG. 9 shows a schematic diagram of battery connections for an embodiment of the device;

FIG. 10 shows a schematic diagram of programming connections for an embodiment of the device;

FIG. 11 shows a schematic diagram of LED connections for an embodiment of the device;

FIG. 12 shows a schematic diagram of accelerometer connections for an embodiment of the device;

FIG. 13 shows a schematic diagram of microcontroller connections for an embodiment of the device;

FIG. 14 shows a print diagram of the PCB;

FIG. 15 shows an example parts list for an embodiment of the device; and

FIG. 16A shows a top view of an empty casing;

FIG. 16B show a bottom view an empty casing with a strap;

FIGS. 16C and 16D show two examples of different PCBs that may be used; and

FIG. 16E shows an overview of the device

### DETAILED DESCRIPTION

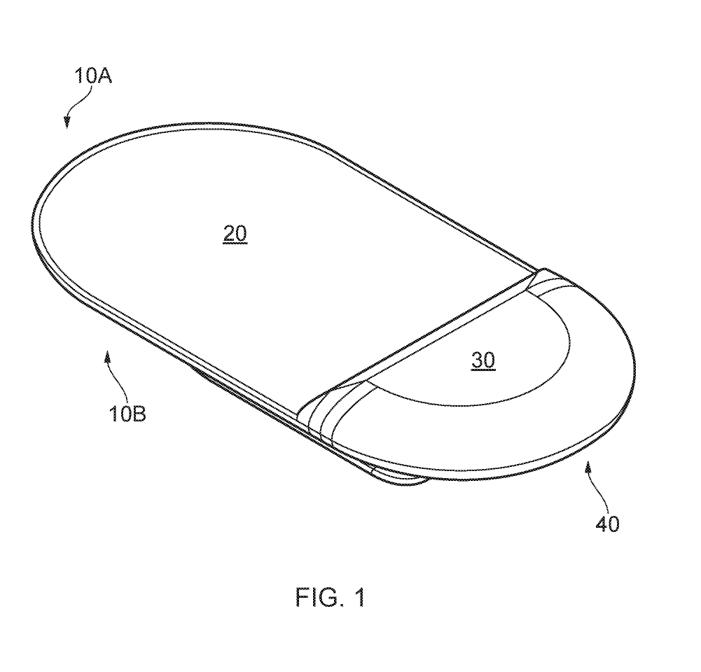

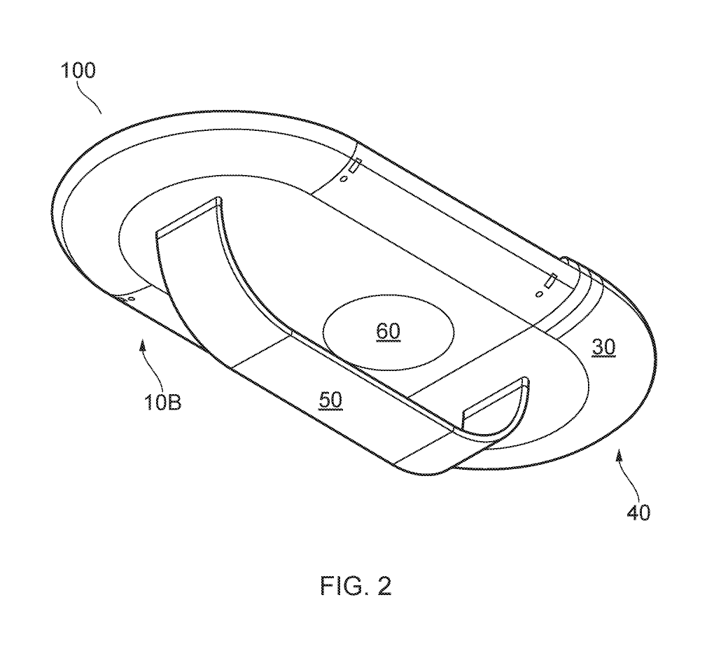

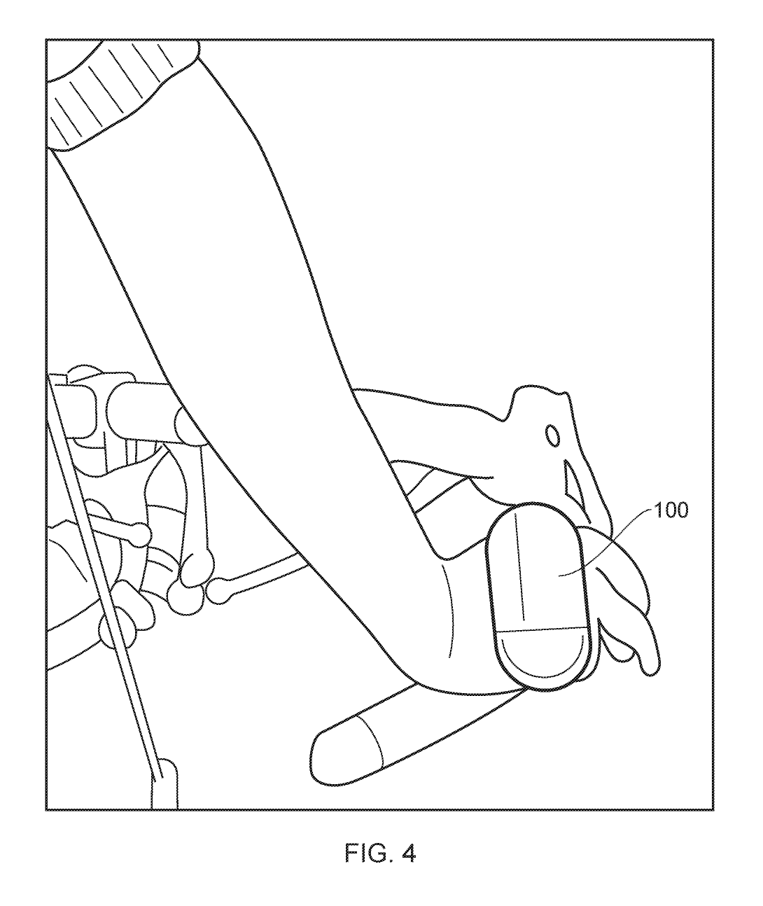

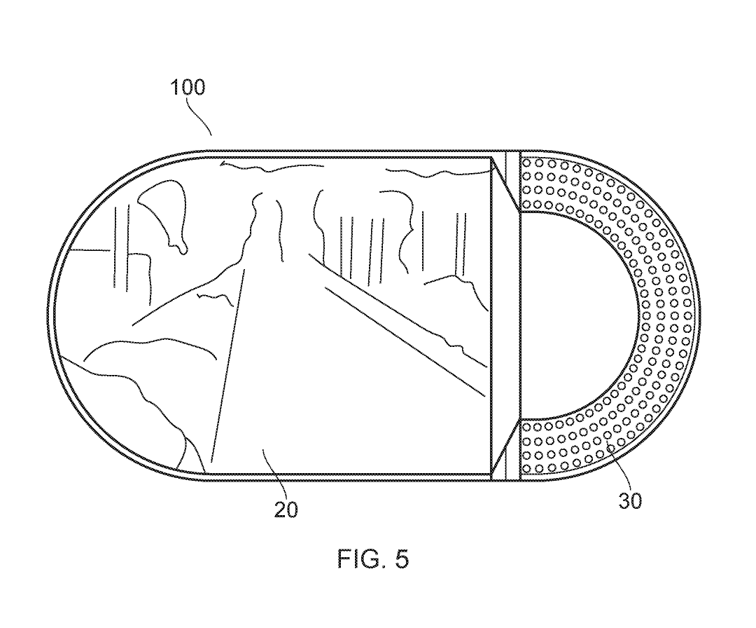

FIGS. 1 to 5 show a preferred embodiment of the mirror and indicator device 100. The device 100 has a first face 10A that houses a mirror 20 and a second face 10B that is adjacent a wearer's hand in use. The device 100 is oblong shaped.

A light 30 is arranged at an end 40 of the device. The light 30 is semi-circular. A strap 50 is arranged on the second face 10B. The strap 50 is arranged to pass across the palm of a wearer's hand so that the mirror 20 faces outwards on a rear face of the hand.

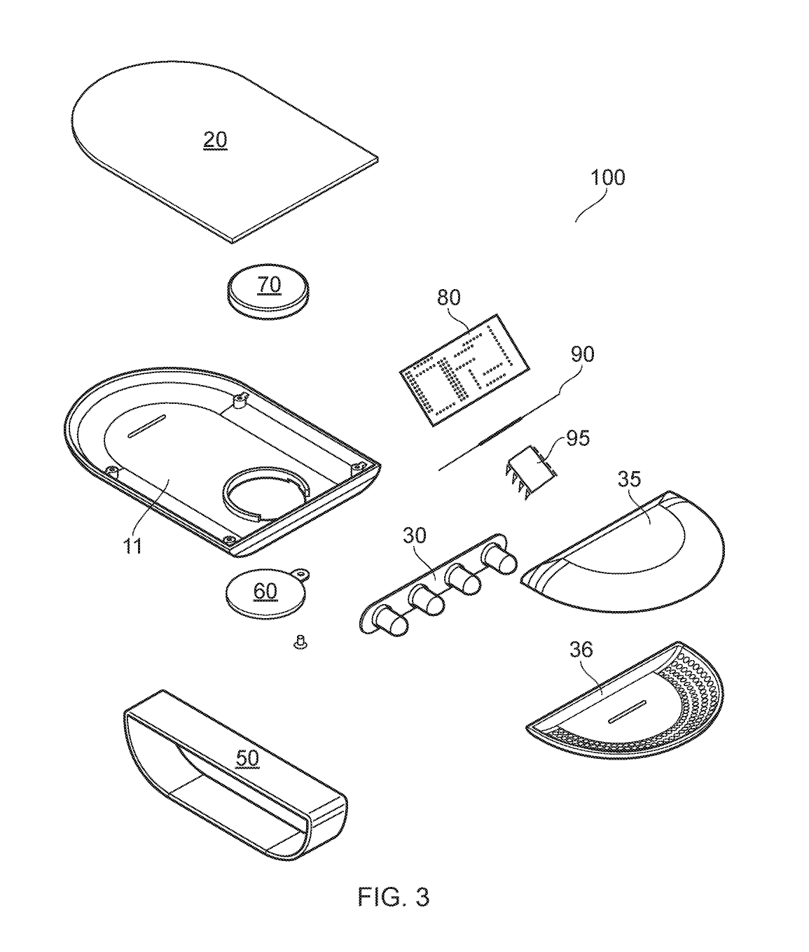

A lid 60 is provided on the second face 10B for covering battery 70. The lid 60 can be removed to access the battery 70. Within the casing 11 of the device is housed a printed circuit board 80 that connects the battery 70, a switch 90 and a microcontroller 95 which triggers a flashing command signal upon receipt of an input signal. The switch 90 shown in FIG. 3 is a reed switch.

In a preferred embodiment the switch 90 is an accelerometer.

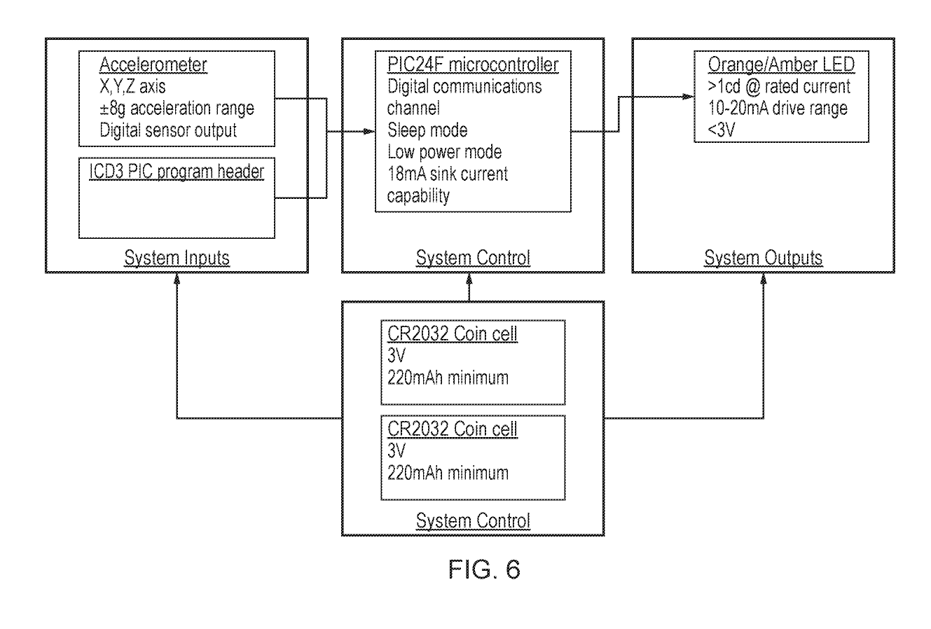

In another embodiment the switch such as an accelerometer or touch sensor may be activated when it is tapped against a rider's helmet (not shown). This process is shown in greater detail in FIG. 6, which is a block diagram indicating system inputs and outputs between the battery 70, accelerometer 90, microcontroller 95 and light 30.

The switch such as the accelerometer 90 is powered by the battery 70 and provides a system input to the microcontroller 95 when the accelerometer 90 is activated in order to trigger the light 30 to flash. Ideally the accelerometer 90 is a 3-axis solid state gyroscope or includes three separate accelerometers.

The microcontroller 95 controls digital communications in the device, enables mode selection, and ensures sinking of current. FIG. 6 shows one example of a circuit diagram for achieving these aims.

Circuit components are arranged on or connected to a printed circuit board (PCB) 80. The components are arranged such that the light 30 when activated, automatically indicates using a flashing orange LED when the user moves their hand in a predefined manner or through a predefined activation range. Preferably the activation range is from a minimum of 0 to 90°. In this way the light 30 is not accidently triggered by wearer movement such as riding over bumps or changing gear or changing riding positions.

The system shown in FIG. 6 is powered continuously from the moment when batteries are inserted. The accelerometer is the only input component to the device. Ideally the accelerometer in FIG. 6 is a 3-axis device and be capable of measuring forces up to ±8 g. Typically the accelerometer is a digital device with a range of interrupt generation and power saving modes available.

In a preferred embodiment the device includes a PIC24F microcontroller 95. A 2 mm right angle pin header (not shown) may be included to allow the device to be programmed and reprogrammed. The microcontroller 95 is capable of sinking current from at least an 18 mA LED 30 continuously and so is capable of operating in a low current consumption mode and includes a sleep function.

A standard 5 mm LED 30 is ideally included in the device, although other light emitting device may be used such as laser LEDs or light emitting polymer (LEP) devices. In some embodiments two or more LEDs may be provided, the additional LED may act as a back-up device or display a different colour. The device 100 may be powered by two CR2032, 3V, 220 mA (minimum), non-rechargeable batteries. Preferably the device 100 is configured to have a long battery life of at least 5 hours.

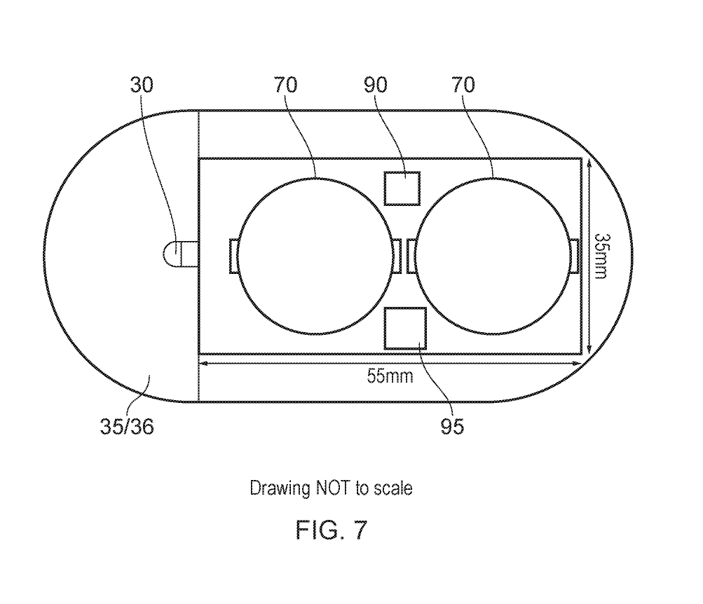

FIG. 7 shows a cross section of the device 100 showing a preferred layout of internal components. As mentioned earlier device 100 has two batteries 70 and one LED 30. The LED 30 is positioned so that it protrudes slightly into a diffuser 36 in order to maximise the light emitted. The LED 30 and diffuser 36 are enclosed by a cover 35. The PCB 80 is secured in place via contact with the casing 11. The casing 11 is moulded to receive the components.

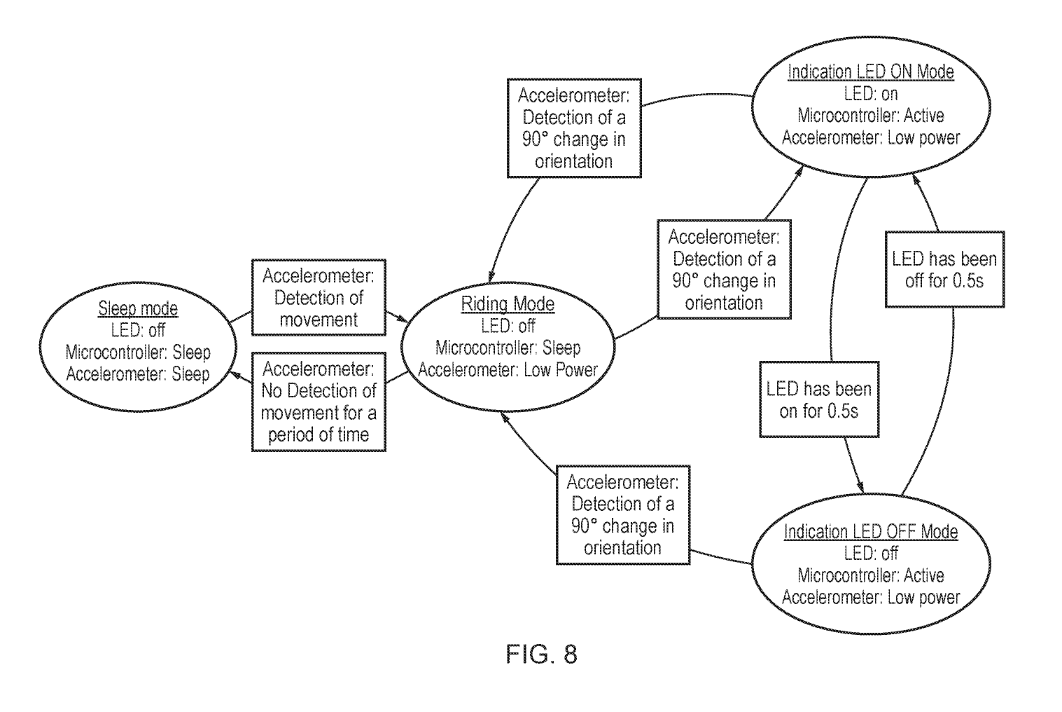

FIG. 8 shows a mode flow chart detailing the firmware for the modes of operation of the device 100. When the device 100 is powered it remains in sleep mode until the accelerometer 90 detects an input force, for example from a predefined motion or designated knock or tap. At this instant the microcontroller 95 senses this and increases current and switches the current to the LED 30 in pulses as well as increasing the sensitivity of the accelerometer 90 so as to allow the device 100 to detect user indicating intentions.

Ideally the action of indicating may be recognised by an orientation change of approximately 90°. The microcontroller 95 preferably includes algorithms and is able to calculate to detect movement and learn to recognise specific user activity to reduce power consumption.

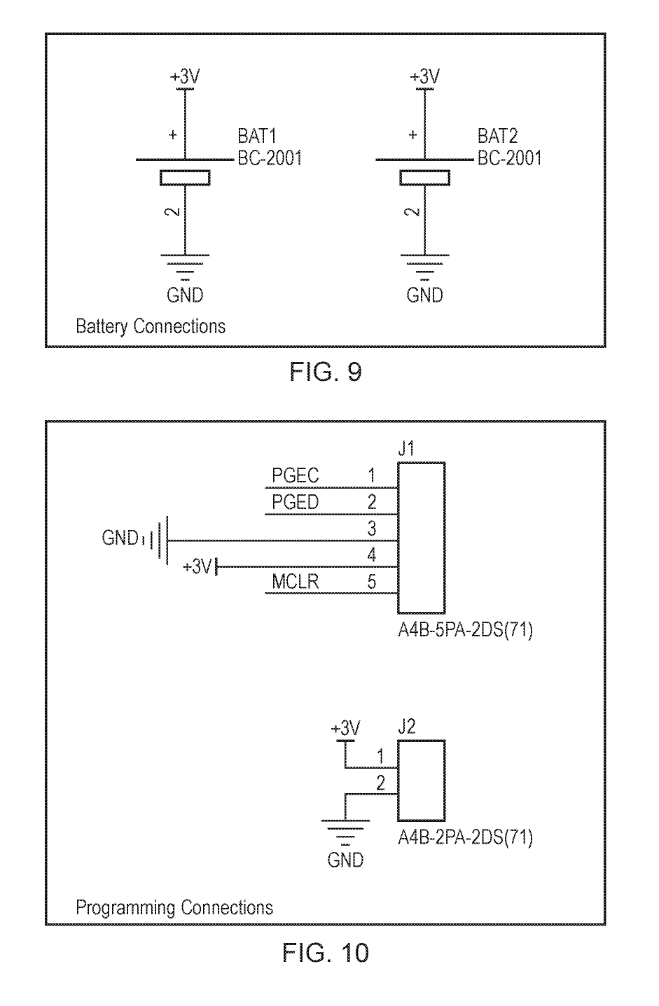

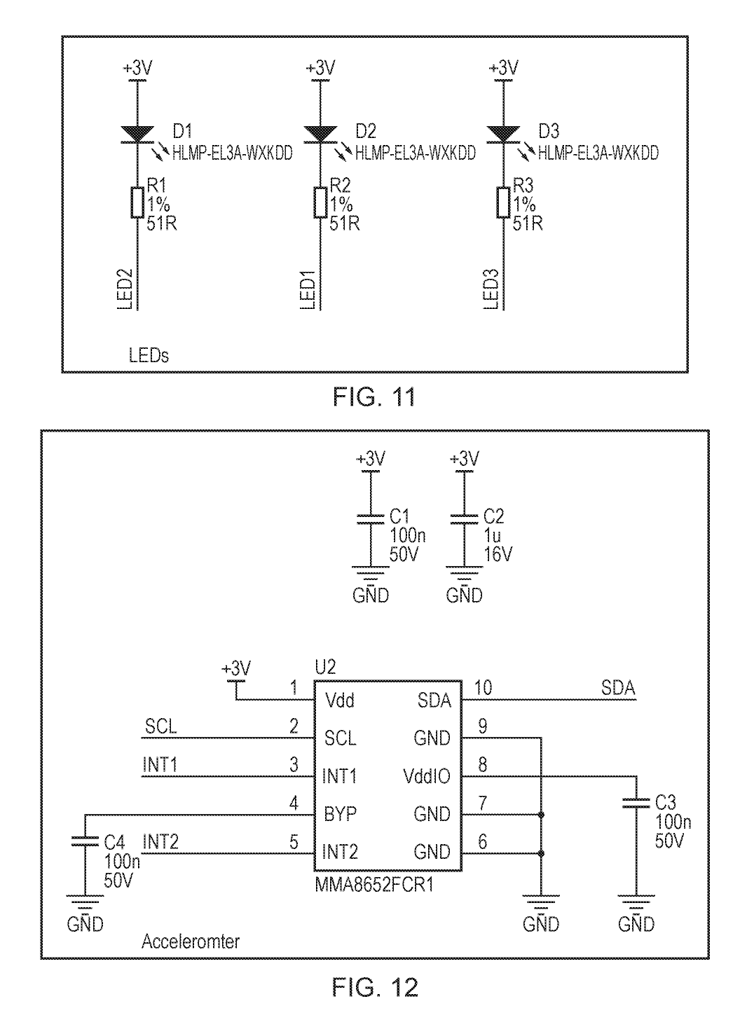

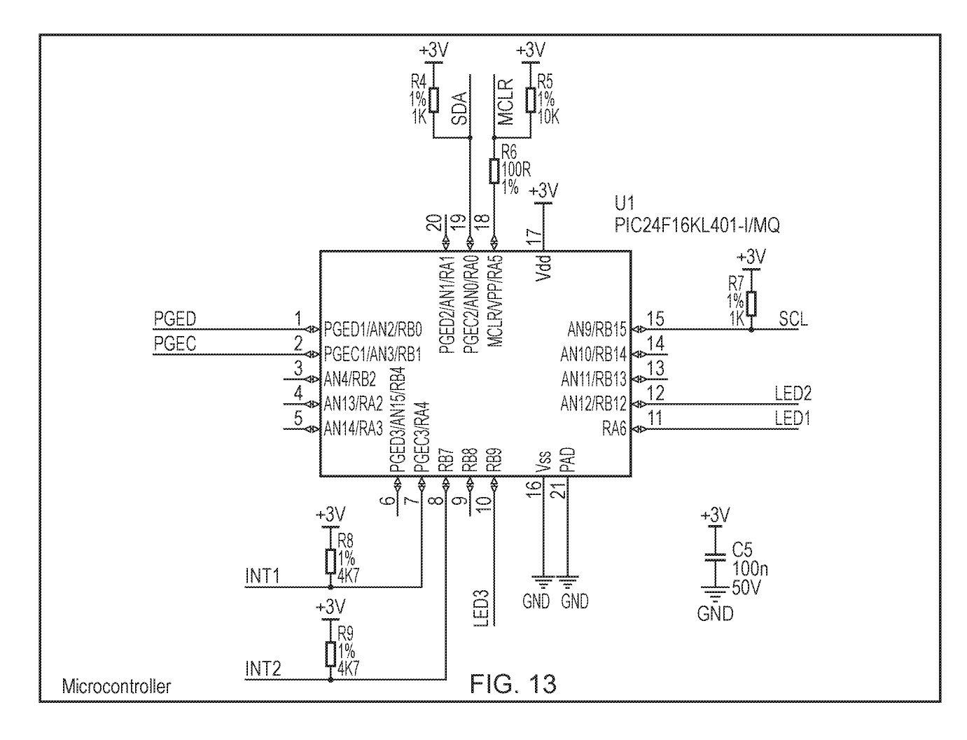

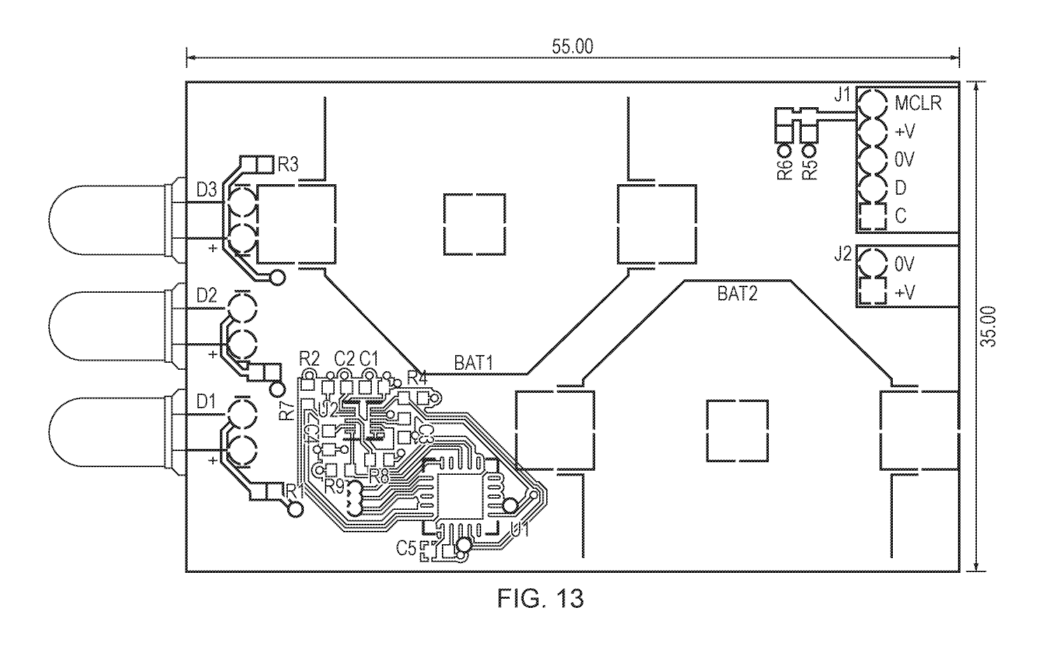

FIGS. 9 to 13 show schematic diagrams of an embodiment of the device.

FIG. 14 shows an example of a PCB print that may be used for the device.

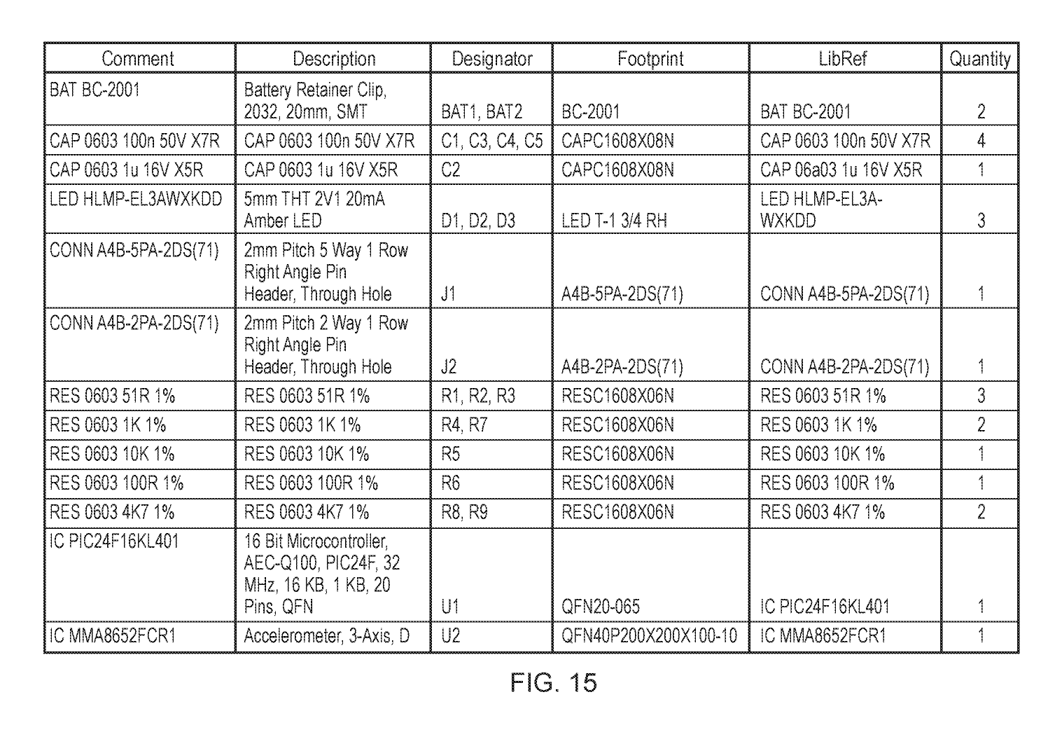

FIG. 15 shows an example of a parts list detailing all components of an embodiment of the device.

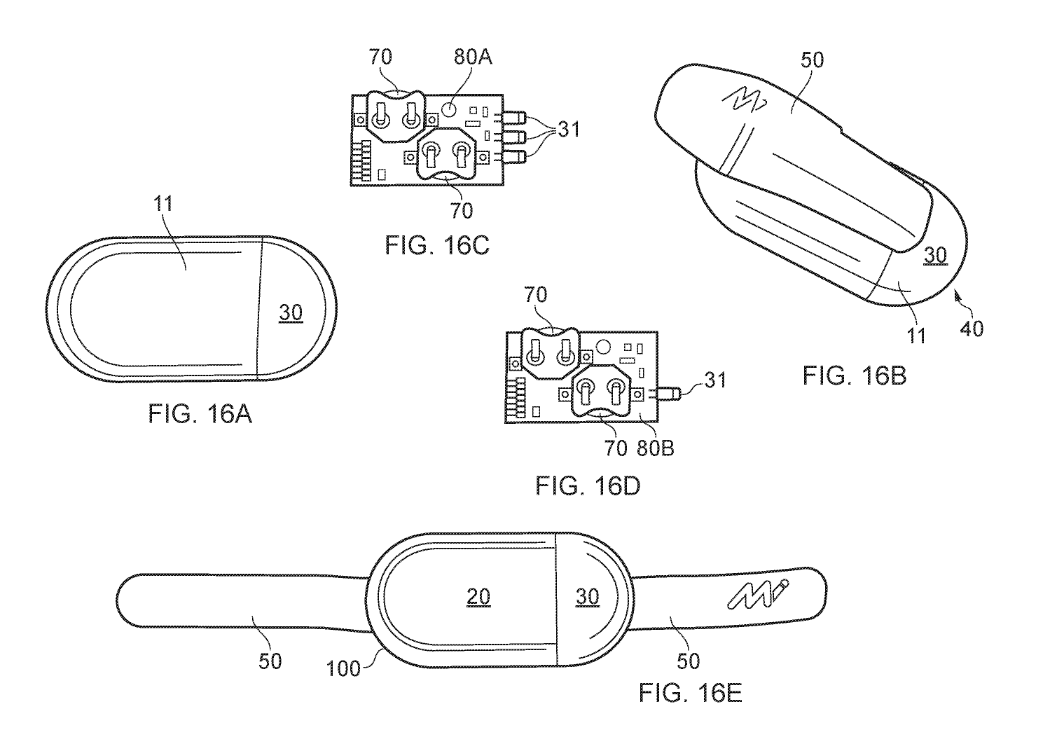

FIGS. 16A and 16B show an empty casing 11 for the device 100. The casing 11 is clear with an orange portion arranged over the light(s) 30.

FIG. 16B shows the strap 50 mounted to the second face of the device 100. The strap 50 is positioned away from the end 40 of the device having the light 30. The strap has two parts that are secured about a wearer's hand by hook and loop means such as Velcro®.

FIGS. 16C and 16D show two examples of different PCBs, 80A, 80B that may be used. The first PCB 80A (FIG. 16C) has 3 LEDs 31 in a row projecting from an edge of the PCB.

The second PCB 80B (FIG. 16D) has three LEDs 31. A first LED surface mounted on a first face of the PCB, a second LED surface mounted on the second face of the PCB and a third LED surfaced mounted on an edge of the PCB. Therefore each LED is arranged to project in a different direction to enhance light emitted. Each PCB 80A, 80B has two batteries 70.

FIG. 16E shows an overview of the device viewed from above. The device has a two part strap 50. The two parts of the strap 50 are arranged around and secured about the wearer's hand in use.

The strap 50 may include text and/or images, such as logo to represent a brand.

The invention has been described by way of example only and it will be appreciated that variation to the aforementioned embodiments may be made without departing from the scope of protection as defined in the claims.

1. A safety mirror and an indicator device for wearing on a hand comprising: a first face housing a mirror and a second opposed face that interfaces a wearer's hand in use; a strap for securing the device to a wearer's hand; a light powered by a battery, the light arranged on an end of the device; the light and the strap are arranged such that the light projects past the hand of the wearer so that the light is not obstructed by the wearer's hand when viewed from a position in front of the wearer during use, wherein the device has a switch operatively connected to the light to activate the light when triggered.

2. A safety mirror and indicator device according to claim 1 wherein the switch includes an accelerometer that is activated upon movement of a wearer's hand.

3. A safety mirror and indicator device according to claim 1 wherein the switch includes a proximity sensor such as a reed switch.

4. A safety mirror and indicator device according to claim 1 wherein the switch includes a touch sensor.

5. A safety mirror and indicator device according to claim 1 wherein the switch is activated by sound.

6. A safety mirror and indicator device according to claim 1 wherein the light is a light emitting diode.

7. A safety mirror and indicator device according to claim 1 wherein the body is substantially oblong.

8. A safety mirror and indicator device according claim 1 including at least one imager.
